(19) United States
(12) Patent Application Publication
(10) Pub. No.: US 2005/0006816 A1
(43) Pub. Date: Jan. 13, 2005

(54) Method and device for shaping a lengthwise corrugated web

(76) Inventors: Henry Drut, Dresden (DE); Frank Weile, Dresden (DE); Andreas Stefan, Dresden (DE); Horst Goldhahn, Dresden (DE)

Correspondence Address: GUDRUN E. HUCKETT DRAUDT, LONSSTR. 53, WUPPERTAL, 42289, DE

(21) Appl. No.: 10/479,795

(22) PCT Filed: Jun. 6, 2002
(86) PCT No.: PCT/DE02/02048

(30) Foreign Application Priority Data
Jun. 8, 2001 (DE) 101 29 018.7

(51) Int. Cl. B31F 1/22

(52) U.S. Cl. 264/286; 425/336

(57) ABSTRACT

In a method and device for continuous shaping of a plane web to a lengthwise corrugated web, wherein the web in the shaping area is continuously spatially guided and shaped, in that any imaginary line positioned within the center plane of the web and extending in the transport direction during shaping in the shaping area travels approximately the same travel distance, with increasing shaping only those web lines not positioned at the edge are subjected to a deflection perpendicularly to the plane of the web. The maximum value of the deflection is the greater the farther the web line is removed from the edge of the web, respectively.

The invention relates to a method and a device for generating lengthwise corrugated webs.

Lengthwise corrugated webs can be used for producing web structures where a gathering of the web transversely to the transport direction is of importance. This is the case for generating a final shape, for example, in the case of lengthwise corrugated cardboard, but also for intermediate shaping steps, for example, when producing a honeycomb structure.

In the packaging material industry and other industries webs with a corrugated cross-section are known. These cross-sections are characterized by periodically repeated shapes. Such shapes can be: sine-shaped lines; lines that are comprised of semi-circles; lines that are combined of circular segments and straight lines; lines composed exclusively of straight lines; or other lines.

Corrugated webs are used, for example, when producing corrugated cardboard. The corrugated web is glued to at least one smooth web. The resulting composite material has a high stiffness and strength in comparison to the minimal mass of the employed material. Because of the structural conditions, the stiffness of the total structure is greater in the direction of the wave front than transverse thereto, i.e., in the direction of the wave normal.

The corrugation of the web according to the prior art is provided by means of a corrugated roller pair. The wave front extends always transversely to the web travel direction. However, corrugated cardboard has in the web travel direction up to 30% better material values than transversely thereto. This results from the fact that, because of the preceding manufacturing steps, the fibers are aligned in the travel direction of the web.

The optimal strength with regard to material and the optimal strength with regard to structure cannot be combined in the case of transverse corrugation. This would be possible with a lengthwise corrugation.

In the case of a lengthwise corrugation method, where by means of a shaping element into the flat web in the travel direction of the web increasingly corrugations are impressed, the simultaneously occurring lateral constriction must be taken into consideration. In this connection, there is the problem of uneven shaping, i.e., the path of a web line extending along the web edge in the travel direction of the web is longer than that of a line extending closer to the center of the web. This causes compression and expansion within the web that during shaping fold or rip the web. In this case, the corrugated paper and thus the entire structure become unusable.

For example, for a width of the flat web of one meter, a width of the corrugated web is 70 cm, and a length of the shaping element of one meter, the web lines positioned at the edge of the web travel a distance that is 1% longer than those at the center of the web. The conventional paper webs cannot compensate such expansion or compression. They rip or form folds.

When the area of deformation in the travel direction of the web is expanded across a wider range in order to reduce the resulting expansions and compressions of the web material, the length of the shaping device becomes too large for integration into a technically realizable device, for example, into a corrugated cardboard machine.

Plane shaping, i.e., deformations where all imaginary web lines extending in the longitudinal direction of the web are of the same length within the shaping area are theoretically realized by shaping shoulders. Shaping shoulders are used, for example, in bag forming machines for producing hoses from plane webs. However, a shaping shoulder for generating lengthwise corrugated webs is not known in the art.

Devices for lengthwise corrugations have been under development for a long time (U.S. Pat. No. 2,257,428; U.S. Pat. No. 2,901,951; U.S. Pat. No. 4,410,316). Often, the above-mentioned problem of non-planar shaping is not taken into consideration. This results in partially high expansions and compressions within the web that lead to high removal forces, wrinkling, and tearing, as described above.

U.S. Pat. No. 4,410,316 dating from the year 1985 has recognized this problem but has not really solved it. It is proposed here to deflect the web via a first roller curve by 90 degrees and, at the same time, to provide for forming lengthwise folds that later on will represent the lengthwise corrugations. The farther the web is transported after passing this first roller curve, the more the individual imaginary web lines in the longitudinal direction will converge and the more the longitudinal folds will be folded onto one another. When the web has reached the desired width, it is then deflected by additional 90 degrees about a second curve having the same radius as the first one and returned into the original conveying direction. In this way, the web lines are aligned again parallel to one another while maintaining the overlapping folds. Subsequently, these folds are positioned upright and shaped to form waves.

In this connection it is to be criticized that the web width reduction required for the lengthwise corrugations and the material loading related to the different travel differences between inner and outer web lines is realized punctiform, in particular, when passing the curves. This shaping that does not occur gradually but very sudden results in a very high material loading. This causes web removal forces that are too great as well as tears.

DE 20 11 802 B2 discloses a machine for generating a lengthwise corrugated web from a sheet-shaped material by means of plane shaping. In the document, the corrugation shaping is described in connection with a guide bed for the web that is designed between intake end and exit end alternatingly convexly or concavely such that the imaginary longitudinal lines and the imaginary transverse lines of the web are of the same length, respectively. As a compensation for the different lengths that result from constriction of the longitudinal lines in the web plane x-y, the web is deflected partially perpendicularly to the web in the z direction. In order to find the geometry of this convexly and concavely curved surfaces, the cross-section of a paper web was selected, as a model, in the intake area as a straight line and in the exit area as a wave. The resulting shape of the paper web was postulated to be the most beneficial shaping geometry. This shaping geometry however is not optimal. For example, according to an embodiment described therein a relatively high deviation in the z direction occurs for a web of 28 cm×108 cm.

However, for the acceptance of a lengthwise corrugation method in the industry it is very important at which ratio of shaping length to web width the lengthwise corrugation can be realized. If the example of DE 20 11 802 B2 were to be extrapolated to the web widths that are conventional in the corrugated cardboard industry, for a desired width of the corrugated web of 2 meters and for a corrugation ratio of 1.5, a web width at the intake of 3 meters would result and for a ratio between shaping length and web width of 108 cm/28 cm=3.86 a shaping length of 11.6 m would result. This is much too long for use in corrugated cardboard machines. A shaping ratio of up to 1 would be necessary.

In a patent that has been recently published, the problem of non-planar shaping has again not been taken into consideration. According to the invention of U.S. Pat. No. 5,508,083, the shaping of the lengthwise corrugations is carried out by means of shaping disks rotating together with the traveling web and impressing the lengthwise corrugation slowly into the web. The invention, relative to the above described prior art, has the disadvantage that it has not been taken into account that this shaping of the lengthwise corrugation is a non-planar shaping and no countermeasures have been proposed in regard to preventing or ameliorating this. This solution has the disadvantage that the shaping path for generating the lengthwise corrugations in the travel direction of the web must be very long, and integration into already existing cardboard machines is therefore difficult.

The lengthwise corrugations are used sometimes also as intermediates for producing honeycomb structures. While honeycomb structures are usually manufactured from webs by cutting and folding (for example, U.S. Pat. No. 5,894,044), the invention DE 197 16 637 proposes to gather a continuously conveyed paper web laterally in the longitudinal direction of the web in order to produce as a pre-stage for the actual honeycomb structure a lengthwise corrugated web wherein the lengthwise corrugations are of a trapezoidal shape. Since this produces, as described above, also a non-planar shaping of the web, the same problems in regard to high web removal forces, tears, and folds will result.

The prior art discloses no method and no device with which continuous lengthwise corrugations can be produced at the same time by a planar shaping action while requiring a minimal shaping length and thus in a way that is industrially applicable.

It is an object of the invention to provide a method and a device with which a plane web transported in the longitudinal direction can be continuously shaped within a relatively short shaping area from a straight web cross-section to a web of a corrugated cross-section without stressing the web such that tears or folds result in the web.

The object is solved according to the invention by a method for continuously shaping a planar web to a lengthwise corrugated web while preventing folds and tears within the web. The method according to the invention is carried out such that the web in the shaping area is spatially continuously guided and shaped in that any imaginary line, which is positioned within the web center plane and extends in the transport direction during shaping in the shaping area, travels approximately the same travel distance, in that with increasing shaping the web lines which are not positioned at the edge are subjected to a deflection perpendicularly to the web plane whose maximum value is the greater the farther the respective web line is positioned away from the edge of the web. For maintaining a constant web length, a smaller deflection in one direction is compensated by a stronger deflection in another direction so that all web lines in the shaping area travel approximately the same travel distance.

In contrast to the prior art according to DE 20 11 802 B2, the web lines which are positioned at the web edge remain almost free of any deflection. Ideally, they form a straight line between intake and exit cross-sections. Only the web lines that are positioned closer to the web center are deflected.

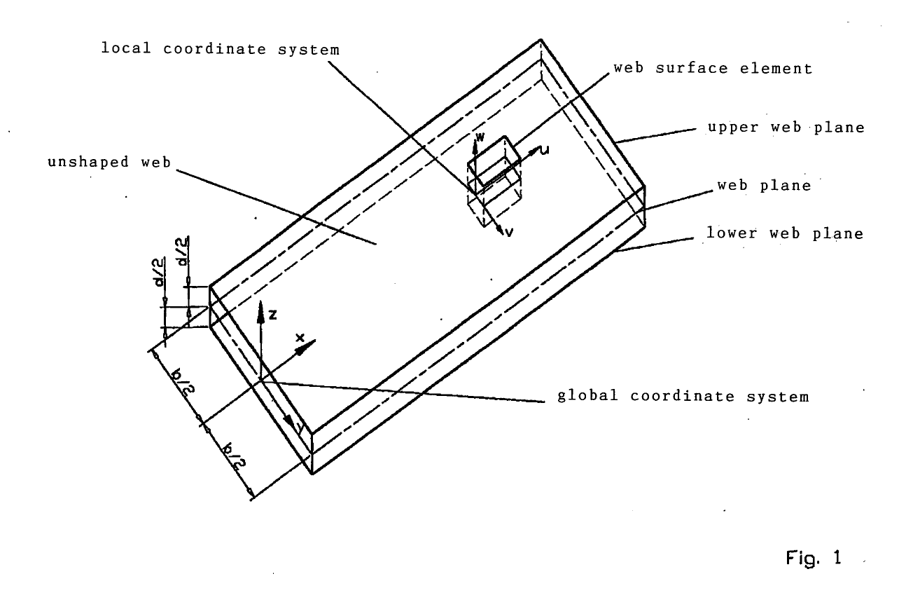

For the following explanations the following definitions illustrated in FIG. 1 apply:

A global Cartesian coordinate system is defined whose x direction, for an unshaped web is positioned in the direction of the greatest extension of the web and therefore coincides with the transport direction of the web. The y axis of this coordinate system extends in the width direction of the web, i.e., transversely to the transport direction, and the z axis in the direction of thickness of the web. The origin of the global coordinate system in the x direction is located at the beginning of the shaping area, in the y direction at half the width, and in the z direction at half the thickness of the web. The width of the web is b, the thickness of the web is d. The plane that in the unshaped state is at z=0 in the x-y plane is the center plane of the web. The upper web plane or lower web plane is defined as the sum of all points which delimit the web in the un-shaped state in a plane parallel to z=d/2 or z=−d/2 parallel to the global x-y plane.

Moreover, for any infinitesimal small volume element of the web a local Cartesian coordinate system is defined whose origin is at z=0 and whose coordinate directions u, v, w in the un-shaped state of the web coincide with the coordinate directions x, y, z of the global coordinate system. When the web is shaped, the orientation of the local coordinate system relative to the global coordinate system is changed accordingly.

The basic idea of the method according to the invention is that all imaginary lines of the web during the shaping process in the travel direction of the web must travel the same travel distance in order to prevent compressions of the material and the resulting negative effects. A determining factor for the web length participating in the shaping is/are the web line or web lines that are most impacted by the constriction of the web with regard to the width of the unshaped web to the width of the corrugated web. This/these web line or web lines must travel the farthest travel distance form the point of entering the shaping device to the shaping tool. For a symmetric shaping, these are the two web lines (web edges) positioned farthest outwardly. For an asymmetric shaping, only one of the two web edges is concerned. The length of this/these web line or web lines is referred to as shaping length. According to the invention, for those web lines that are less impacted by the constriction, the shaping length is maintained constant, so that these web lines are subjected to a deflection in the z direction. For a symmetric shaping the deflection is the greater the closer the web line is positioned to the center of the web.

In one embodiment of the invention, the differences of the web line lengths that are to be compensated during shaping by deflection in the z direction, are reduced by curving the web before the above described web shaping is carried out. Curving of the web means that the web, by bending about the x axis, is deformed such that the cross-sectional plane delimited by the thickness and width is transformed from an originally rectangular shape into an arc shape. The lines at the edge of the web are then positioned closer towards the center of the web and the constriction required for shaping the corrugations of the web in the shaping area is reduced.

The curved web, for example, can have a semi-circular curvature of the cross-section, i.e., the line of intersection of the center plane of the web and the intake cross-section plane of the shaping area is a circular arc in this case. Other curvature shapes are also suitable. Such a web curvature can be produced, for example, by a shaping shoulder.

Shaping is preferably designed such that a uniform transition from the non-corrugated to the corrugated structure is realized and the web is loaded by shaping as uniformly as possible and not punctiform. In this way, the formation of tears and folds within the web is prevented.

In the method according to the invention, the web is shaped such that the initially plane center plane of the web is shaped to a doubly curved surface with the following properties. This surface will be referred to in the following as the shaping surface. At the end of the method, the lengthwise corrugated web is present. The most important property of the shaping surface resides in that every web line contained therein has the same length. In more general terms, the shaping surface can be described as follows.

The shaping surface is surrounded by four boundary lines which intercept one another in pairs at one point each. Two oppositely positioned boundary lines of this shaping surface have the same length so that to each point of one boundary line one point of the opposite boundary line can be assigned.

The boundary lines of one pair of oppositely positioned boundary lines, i.e., the edges of the web, can be projected onto one another for symmetric shaping by mirror imaging on a plane.

The boundary lines of the other pair of oppositely positioned boundary lines represent a connection extending at least approximately in one plane each (intake cross-section plane or exit cross-section plane) of two points positioned in that plane (intake cross-section line or exit cross-section line), respectively. Advantageously, the intake cross-section plane and the exit cross-section plane are arranged approximately parallel relative to one another in space. The shaping surface extends between them. The intake cross-section line can be straight or curved. The exit cross-section line is comprised of a plurality of adjoining partial straight or curved lines positioned in one plane.

For producing corrugated cardboard, a combination of sine-shaped lines, of lines comprised of semi-circles, lines comprised of circular segments and straight lines, lines comprised only of straight lines, or other lines are expedient.

Any of the web lines located within the doubly curved shaping surface that represents in the shaping surface the shortest connection of a point of the intake cross-section line with the corresponding point of the exit cross-section line, is at least approximately as long as the two web edges. In an advantageous configuration of the invention, each one of these web lines intercepts approximately perpendicularly the intake cross-section plane and the exit cross-section plane.

The important difference of the method according to the invention to those according to the prior art resides in the deflection of the web lines positioned within the interior of the web in the z direction, wherein the amplitude of this deflection depends on the y coordinate of the respective volume element of the web. The tangential displacement of the infinitesimal web elements relative to one another that, as a result of the deflection in the z direction are minimal but inevitably necessary, are minimized in that the web edges are not deflected or deflected only insignificantly in the z direction. It has been proven that for a width of the flat web of one meter, a width of the corrugated web of 70 cm, and a shaping length of one half meter, the expansions or constrictions remain within a range that is acceptable for the web material. The ratio between web width at the intake and the shaping length in this case is 0.5. Such a shaping device corresponds thus to the requirements for realization within industrial corrugated cardboard machines.

For performing the method according to the invention, according to the teaching of the invention a device is used that comprises one or several shaping elements for guiding the web to be shaped, wherein the shaping element/s deflect the web in the z direction over portions thereof differently such that the shaping travel of all web lines defined by the shaping elements is at least approximately identical.

In the device according to the invention, the web is stored on a storage roller. The web removal action is realized by means of a pair of feed rollers positioned between the storage roller and the shaping shoulder.

For shaping a straight web cross-section to a corrugated web cross-section, the web is supplied to the shaping part of the device in a planar state. The shaping part of the device can be comprised of two shaping elements with planar or curved boundary intake cross-section line into which the web enters plane or curved. As an option, a device for curving the web, for example, a shaping shoulder, can be positioned upstream of the shaping element.

When shaping elements with curved boundary intake cross-section line are used, a shaping shoulder arranged upstream of the shaping elements can be used for shaping the web from a plane into a curved state. The web passes between the shaping shoulder and a cylinder segment. The curved part of the web is supported by the cylinder segment.

When using shaping elements with straight intake cross-section, curving of the web can be omitted and the web can be transported in the planar state into the shaping area.

The web is guided subsequently through a shaping gap formed between two shaping elements. The areas of the shaping elements contacting the web are configured such that a forced guiding action is provided for the web by the gap between the shaping elements, wherein the forced guiding action provides that each imaginary web line, positioned within the center plane of the web and extending in the longitudinal direction of the web, has at least approximately identical length in the shaping area of the shaping elements. In this way, the transport of the web through the gap between the shaping elements is realized almost without any constriction or expansion of the material. The contortions of the material resulting from the material thickness being different from zero in the edge areas (z≠0) are negligibly small.

The web exits the shaping element in the corrugated state. The driving action of the web is realized by a pair of main removal rollers that are provided already with the shape of the corrugated web on their outer surface.

Shaping is realized by shaping elements that are positioned on both sides of the web. In one embodiment of the invention, these shaping elements are solid bodies on which the desired shaping contour is impressed into the side facing the web so that in the mounted state a forced guiding for the web to be shaped is provided. The shaping elements are arranged in the shaping path of the device according to the invention such that the two sides into which the shaping contour is impressed are facing one another. In this connection, between the facing sides of the shaping elements a gap is provided that is so large that the web can pass through the gap without any impairment, wherein a corrugated contour is imparted to the web can pass without any impairment, wherein a corrugated contour is imparted to the web.

The shaping elements of the preferred embodiment is a solid body with at least one doubly curved functional surface.

The concrete shape of the functional surfaces results mandatorily from the desired shape of the shaping surface, i.e., the shape that is to be imparted to the center plane of the web during the shaping process. The functional surfaces are surfaces that envelope the shaping surface from one side, respectively, such that the perpendicular spacing from the shaping surface relative to the functional surface is constant at every point. The minimum size for this spacing is half the thickness d of the web, optionally plus an additional amount for an air gap for reducing friction.

Friction between the shaping elements and the web can also be reduced according to the invention by friction-reducing measures on the surface of the shaping elements or by constructive measures.

Friction-reducing measures on the surface can be: use of low-friction shaping element materials, use of low-friction surface coatings, use of friction-reducing lubricants, for example, air, and providing friction-reducing surface structures.

Constructively friction-reducing measures can be: gliding elements that are embedded into the shaping contour, for example, balls or belts circulating together with the web. The shaping elements can also be configured such that the shaping contour is formed by the balls or the entrained circulating belts themselves.

The curvature of the web is realized always planar when using a shaping shoulder—all areas of the web travel during shaping at least approximately the same travel distance. The shaping shoulder of the device according to the invention has in the above described example in the travel direction of the web an extension of less than half a meter.

An important advantage of the invention resides in that the shaping length is relatively minimal. The lengthwise corrugation device according to the invention can therefore be integrated, for example, in already existing corrugated cardboard machines. Moreover, when manufacturing corrugated webs according to the invention or with the device according to the invention, folds caused by material constriction as well as tears caused by overextension are prevented. The webs produced according to the invention have a strength that is optimized with regard to material and structure.

The method according to the invention and the device according to the invention can be used advantageously for generating trapezoidally lengthwise corrugated webs as an intermediate stage for forming honeycombs.

Advantageous embodiments of the invention will be explained in the following by means of illustrations. It is shown in:

FIG. 1 definitions of important parameters;

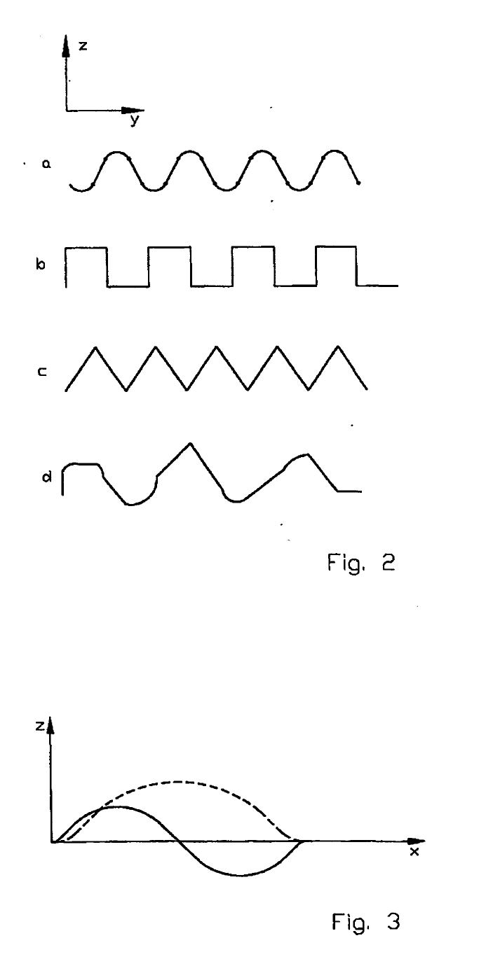

FIG. 2 examples of possible corrugation profiles that can be produced with the method according to the invention;

FIG. 3 exemplary possible web line extensions in the shaping area;

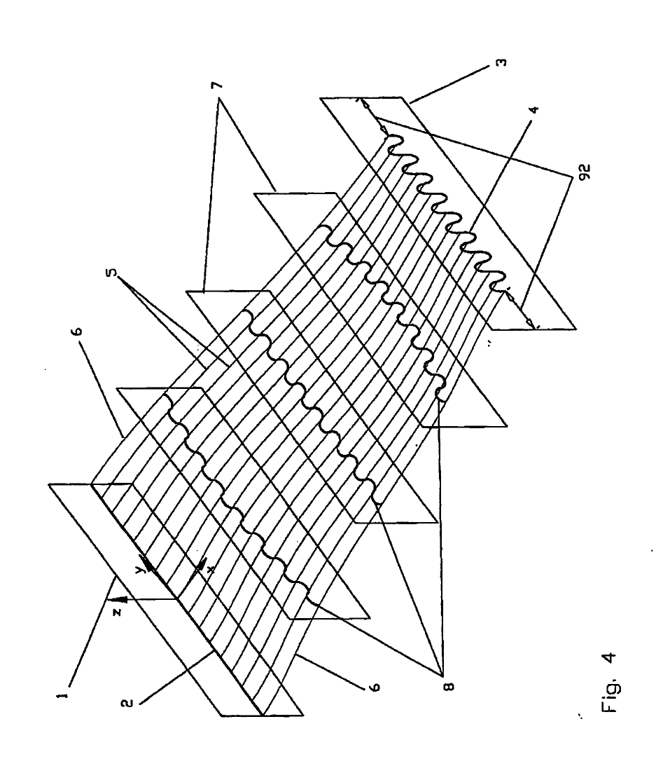

FIG. 4 the extension of selected web lines when shaping a web that is planar in the intake cross-section plane to a web having a corrugated web cross-section;

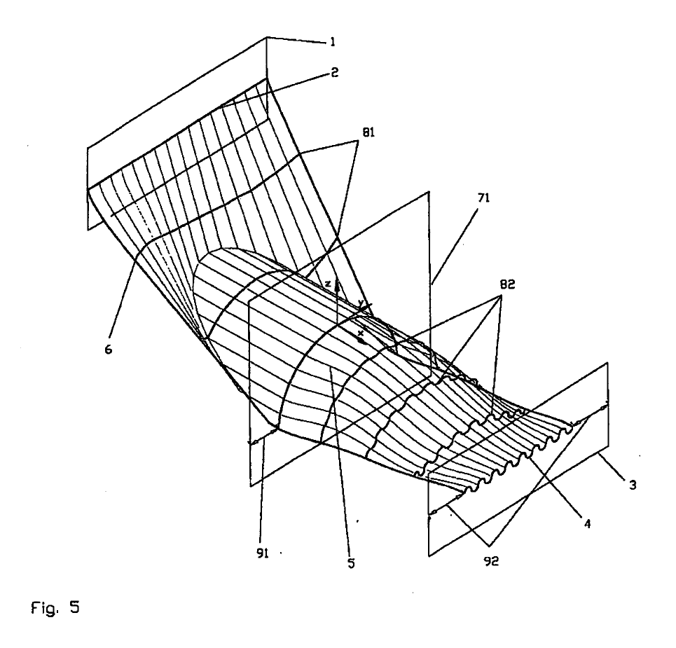

FIG. 5 the extension of selected web lines when shaping a web that is curved in the intake cross-section plane to a web having a corrugated web cross-section;

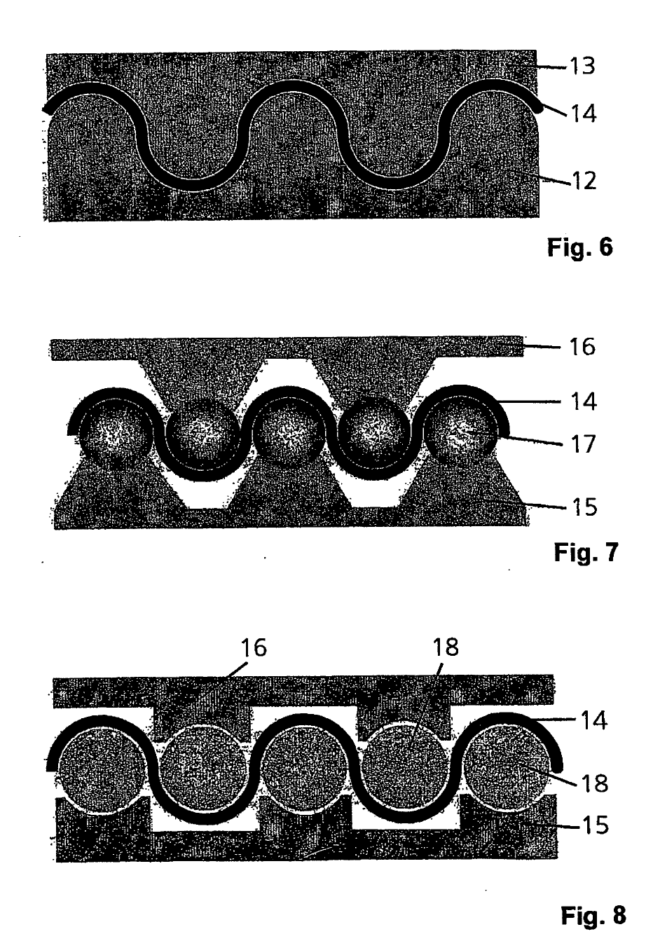

FIG. 6 a cross-section of shaping elements and a web, wherein the surface of the shaping elements contacting the web is a solid body;

FIG. 7 a cross-section of shaping elements and a web, wherein the surface of the shaping elements contacting the web is formed by balls embedded in the shaping element;

FIG. 8 a cross-section of shaping elements and a web, wherein the surface of the shaping element contacting the web is formed by belts embedded in the shaping element;

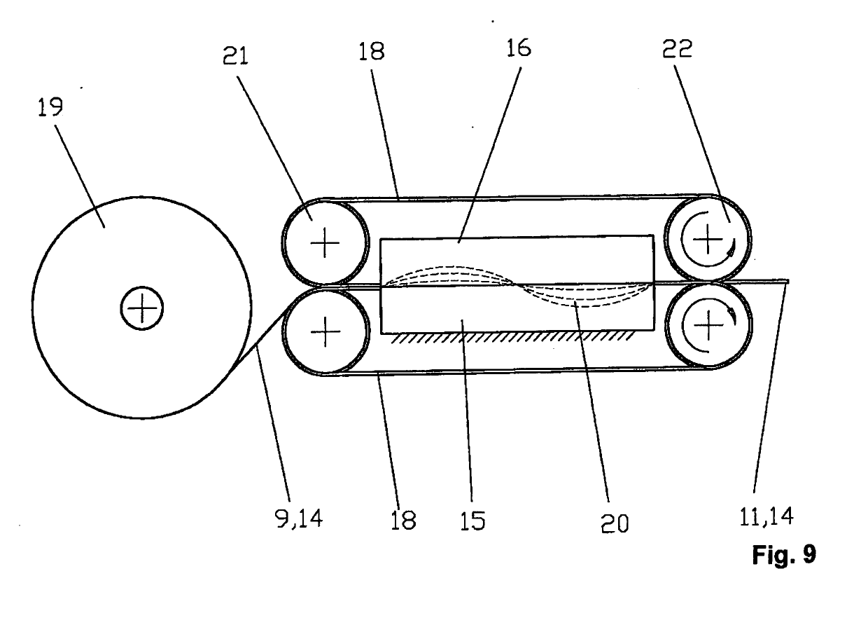

FIG. 9 a web shaping device according to the invention with shaping elements for shaping a plane web to a web having a corrugated web cross-section;

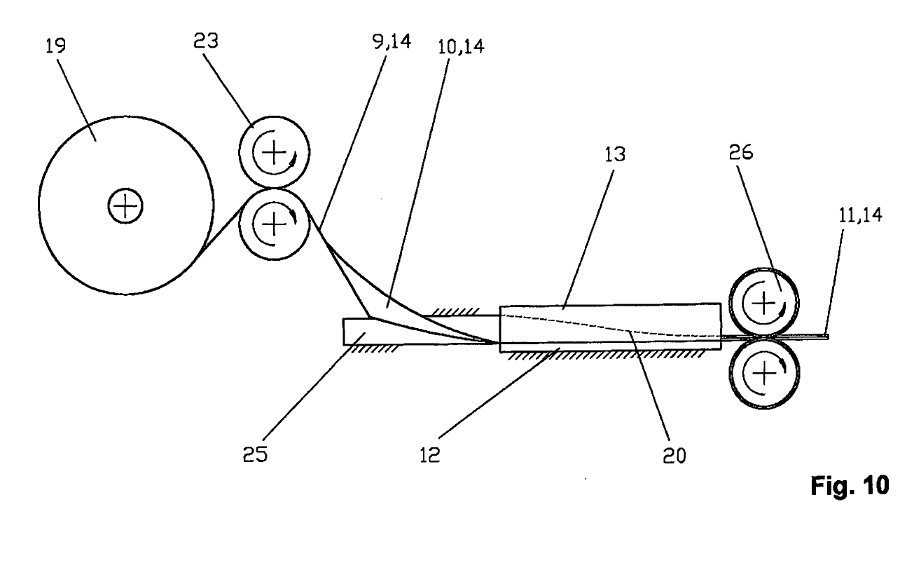

FIG. 10 a web shaping device according to the invention with shaping elements and shaping shoulder for curving a plane web and for subsequent shaping to a web with a corrugated web cross-section.

The definitions illustrated in FIG. 1 of coordinate systems and dimensions of the web have been explained already in connection with the summary of the invention.

In FIG. 2 corrugated profiles are illustrated which can be generated with the method according to the invention. They only represent examples of use; many other cross-sectional profiles can be realized.
Illustration (a) shows a corrugated profile that is comprised of a periodically repeated arrangement of straight lines and circular arcs and is suitable, for example, for manufacturing corrugated cardboard;
Illustration (b) shows a profile which is similar to the course of a square wave;
Illustration (c) shows a profile which is similar to the course of a triangular wave;
Illustration (d) shows a profile that is comprised in random sequence of straight lines and circular arcs. Such arrangements can be repeated at random or periodically.

FIG. 3 shows as an example possible web line extensions in the shaping area. Advantageous for an unimpaired material flow and thus for a complication-free performance of the method according to the invention are web line courses whose slant in the area of the intake cross-section plane and exit cross-section plane is zero so that the web intercepts these planes perpendicularly across the entire width. In this connection, many different concrete configurations are possible. Particularly advantageous is the use of polynomials that are placed into the shaping area such that their ascent relative to the points of penetration of the intake cross-section plane and the exit cross-section plane is zero.

In FIG. 4, a first embodiment of the method according to the invention is illustrated. In this connection, the web to be shaped is supplied to the shaping area in the planar form. The web enters planar and perpendicular to the intake cross-section plane (1) the shaping area. The intake cross-section plane is positioned parallel to the y-z plane of the global coordinate system. The center plane of the web extends in this area parallel to the x-y plane of the global coordinate system. The line of interception between the intake cross-section plane and the center plane of the web is a straight line. It is referred to as intake cross-section line (2).

The web passes through the cross-section planes (7) with the cross-section lines (8) and is subjected to increasing shaping. At the end of the shaping area, the finish-shaped web exits perpendicularly to the exit cross-section plane (3) that extends parallel to the intake cross-section with the constriction (92) from the shaping area. The line of interception between the exit cross-section plane (3) and the web center plane corresponds to the corrugated profile that was to be imprinted on the web. It is referred to as exit cross-section line (4). The exit cross-section line (4) is a sine-shaped line.

The web lines (5) illustrated in the Figure are those lines within the web that are positioned in the zero crossing (on the antisymmetry axis) of the sine-shaped exit cross-section lines (4), i.e., those that in the advantageous embodiment of the invention intercept the intake cross-section plane 1 and the exit cross-section plane (3) having the same z coordinate. In this way, a particularly disruption-free material flow can be achieved.

In another advantageous configuration of the invention, the intake cross-section line and the antisymmetry axis of the exit cross-section line (4) have different z coordinates. In this way, the horizontal length of the shaping area can be reduced.

The outermost web lines are the web edges (6). They are impacted most strongly by the reduction of the y extension (constriction 92) of the web in the shaping area.

In an advantageous configuration of the method according to the invention, the web edges (6) over the entire shaping area have a constant z coordinate. All other web lines would have a shorter length than the web edges (6) when the z coordinate between the intake cross-section plane (1) and the exit cross-section plane (4) is also constant. Accordingly, these web lines according to the method of the invention are deflected in the shaping area in the z direction and this all the more the less they are impacted by the constriction. As a result of the symmetry of the shaping action in the preferred embodiment of the invention, the web lines (5) are to be deflected all the more the closer they are positioned to the center of the web (y=0).

In the preferred configuration of the method according to the invention, the deflection of all web lines (5) is carried out according to a polynomial of the fifth order that is designed such that its ascent at the points of interception relative to the intake cross-section plane and the exit cross-section plane is zero and its amplitude depends on the y-coordinate of the respective web lines in the intake cross-section plane so that the z deflection of the web edges across the entire length of the shaping area is zero while the web line in the center of the web is subjected to the greatest deflection, respectively.

FIG. 5 shows a perspective view of a web in the shaping area which is shaped from a straight intake cross-section line (2) to a curved one and is then shaped to a corrugated exit cross-section line (4). The web enters in the plane state a shaping shoulder and passes the cross-section lines (81). In the curved state, it leaves the shaping shoulder in the cross-section plane (71) with the constriction (91) and enters the shaping area formed by the shaped elements. Within the shaping area, across the cross-section lines (82) the further tapering of the web and the shaping of the corrugated cross-section take place. Subsequently, the finish-shaped web exits the shaping area with a corrugated exit cross-section line (4) and constriction (92).

Shaping in the shaping area is effected by the shaping elements that are provided on both sides of the web and, on the side facing of the web, are provided with the above described shaping surfaces.

FIG. 6 shows a cross-section of the shaping elements and a web wherein the surface of the shaping elements in contact with the web is a solid body. The shaping elements are comprised of a bottom mold (12) and top mold (13). Between them, the web (14) is arranged. The surfaces of the bottom mold (12) and top mold (13) facing the web are preferably designed to have low friction. This can be achieved by a suitable selection of surface materials, but also by adding gliding agents, for example, air.

FIG. 7 shows a cross-section of shaping elements and a web wherein the surface of the shaping elements in contact with the web are formed by balls (17) embedded in the shaping element. The balls are supported in a lower (15) and an upper (16) shell. The web (14) is not in contact with the bearing shells (15, 16) but only with the balls (17). In this way, a reduction of the friction forces can be achieved.

FIG. 8 shows a cross-section of shaping elements and a web (14), wherein the surface of the shaping elements in contact with the web (14) is formed by belts (18). They, in turn, are supported in correspondingly shaped lower (15) and upper (16) bearing shells. In this variant, a relative movement between the web (14) and the shaping belts (18) is prevented as much as possible. The friction pairing of the belts (18) and the bearing shells (15, 16) can be designed to be low-friction and wear-resistant as much as possible by conventional means known in the technical field. When a removal force is imparted to the belts (18) by suitable means, the web (14) can then be transported without additional removal devices through the shaping device.

FIG. 9 shows a web shaping device according to the invention with shaping elements for shaping a straight web cross-section to a corrugated web cross-section.

The web (14) is stored on a storage roller (19) and leaves it in a planar state (9). The planar web (14) is guided into a shaping element comprised of lower (15) and upper (16) bearing shells and belts (18). The areas of the shaping element or the belts (18) in contact with the web (14) are designed such that a web surface (20) as illustrated in FIG. 4 will result. The endless belts (18) are guided about the backside of the lower (15) and upper (16) bearing shells by means of a forward (21) and a rearward (22) deflection roller. The lower deflection roller (22) is driven so that the belts (18) as well as the web (14) are pulled through the shaping element. At the exit of the shaping element and the rearward deflection roller (22), the web is present in the lengthwise corrugated state (36).

FIG. 10 shows a web shaping device according to the invention with shaping elements and shaping shoulder for shaping a straight web cross-section to a curved cross-section and for shaping the curved web cross-section to a corrugated one.

The web (14) is stored on a storage roller (19) and is removed therefrom in a planar state (9). The web drive is realized in this embodiment by a feed roller pair (23). The web is shaped from the straight (9) into a curved (10) cross-section by means of a shaping shoulder that is covered in FIG. 8 by the curved web. The curved portion of the web is supported by means of a cylinder segment (25). The web passes between the shaping shoulder and the cylinder segment (25).

The curved web (10,14) in this embodiment is guided through a shaping element that is comprised of a bottom (12) and a top mold (13). The areas of the shaping element contacting the web (14) are configured such that a web surface (20) illustrated in FIG. 5 results. The web (14) leaves the shaping element (12, 13) in a corrugated state (11). Removal of the web (14) is realized by means of a pair of main removal rollers (26) having peripheral surfaces that are already provided with the shape of the corrugated web (11,14).

List of Reference Numerals

1 intake cross-section plane
2 intake cross-section line
3 exit cross-section plane
4 exit cross-section line
5 web line
6 web edge
7 cross-sectional plane
71 cross-sectional plane at the transition between shaping shoulder and shaping element
8 cross-sectional line
81 cross-sectional line at the shaping shoulder
82 cross-sectional line at the shaping element
91 constriction caused by the shaping shoulder
92 constriction at exit
12 bottom mold
13 top mold
14 web
15 lower bearing shell
16 upper bearing shell
17 balls
18 belts
19 storage roller
20 shaping surface
21 leading deflection roller
22 trailing deflection roller
23 feed roller pair
24 shaping shoulder
25 cylinder segment
26 main removal roller pair

1. A method for continuous shaping of a plane web to a lengthwise corrugated web, wherein the web in the shaping area is continuously spatially guided and shaped, in that any imaginary line positioned within the center plane of the web and extending in the transport direction during shaping in the shaping area travels approximately the same travel distance, wherein with increasing shaping only those web lines not positioned at the edge are subjected to a deflection perpendicularly to the plane of the web whose maximum value is the greater the farther the web line is removed from the edge of the web, respectively.

2. The method according to claim 1, wherein the deflection of the web lines that is perpendicular to the web plane is realized in the same direction at any location.

3. The method according to claim 1, wherein the deflection of the web lines that is perpendicular to the web plane is subjected to a directional reversal approximately at the center of the shaping area.

4. The method according to claim 1, wherein the web is pre-shaped from its planar state first into a curved state and is then shaped into a web with corrugated cross-section.

5. The method according to claim 4, wherein a shaping shoulder is used for shaping the web curvature.

6. A device for continuous shaping of a plane web to a lengthwise corrugated web, wherein one or several shaping elements are arranged in the device for guiding the web to be shaped for deflecting the web over portions thereof perpendicularly to the web plane, wherein the shaping travel of all web lines defined by the shaping elements is approximately identical in length.

7. The device according to claim 6, wherein the shaping elements are formed as solid bodies on which the desired shaping contour is impressed on the side facing the web, respectively, such that they provide in the mounted state a forced guiding action for the web to be shaped, wherein the shaping elements in the shaping path of the device according to the invention are arranged such that those two sides are facing one another in which the shaping contour is impressed, wherein between the facing sides of the shaping elements a gap is located that is so large that the web can pass it without impairment.

8. The device according to claim 6, wherein glide elements circulating together with the web are embedded within the contour of the shaping elements facing the web, for example, balls or belts circulating together with the web.

9. The device according to claim 6, wherein the shaping contour itself is formed by balls or by belts circulating with the web.

10. The device according to claim 6, wherein a shaping shoulder is arranged in front of the shaping elements in the travel direction of the web.

11. A shaping element for continuous shaping of a plane web to a web that is corrugated in the transport direction, comprising at least one doubly curved functional surface that is surrounded by four boundary lines that intercept one another in pairs at a point, respectively, wherein the functional surface, starting from a straight or curved intake cross-section line to the curved exit cross-section line has an increasing shaping, wherein every imaginary web line positioned within the functional center plane and extending from the intake cross-section line to the exit cross-section line has substantially the same length in the shaping area and wherein, with increasing x coordinate, the web lines not positioned on the edge are subjected to a deflection perpendicularly to the plane of the functional surface whose maximum value is the greater the farther the respective web line is removed from the edge of the web.
